(19) United States
(12) Patent Application Publication
(10) Pub. No.: US 2013/0181665 A1
(43) Pub. Date: Jul. 18, 2013

(54) WIRELESS POWER TRANSMITTER, WIRELESS POWER RECEIVER, AND CONTROL METHODS THEREOF

(71) Applicant: Samsung Electronics Co., Ltd., Gyeonggi-do (KR)

(72) Inventors: Kyung-Woo LEE, Seoul (KR); Kang-Ho Byun, Gyeonggi-do (KR); Se-Ho Park, Gyeonggi-do (KR)

(73) Assignee: Samsung Electronics Co., Ltd., Gyeonggi-do (KR)

(21) Appl. No.: 13/743,021

(22) Filed: Jan. 16, 2013

Related U.S. Application Data
(60) Provisional application No. 61/587,300, filed on Jan. 17, 2012.

(51) Int. Cl. H02J 7/00; H02J 7/02

(52) U.S. Cl. CPC H02J 7/007; H02J 7/025
USPC 320/108; 320/137

(57) ABSTRACT

Disclosed is a control method of a wireless power transmitter for transmitting charging power to a wireless power receiver. The control method includes receiving a communication request signal for transmitting a wireless power from the wireless power receiver, determining whether to set a communication with the wireless power receiver based on the received communication request signal, when it is determined to set the communication with the wireless power receiver, transmitting a charge command signal to control an on state of a load switch at a predetermined point in time to the wireless power receiver, applying the charging power and detecting a load change by the wireless power receiver at the predetermined point in time.

### PRIORITY

This application claims priority under 35 U.S.C. §119(a) to a U.S. Provisional Patent Application entitled “Wireless Power Transmitter, Wireless Power Receiver, and Control Method Thereof” filed in the United States Patent and Trademark Office on Jan. 17, 2012 and assigned Ser. No. 61/587,300, the entire contents of which are incorporated herein by reference.

### BACKGROUND OF THE INVENTION

1. Field of the Invention

The present invention relates generally to a wireless power transmitter and a wireless power receiver, and control methods thereof, and more particularly, to a wireless power transmitter and a wireless power receiver capable of performing communication in a predetermined manner, and control methods thereof.

2. Description of the Related Art

Mobile terminals such as a mobile phone, a PDA (Personal Digital Assistant) and the like are driven by rechargeable batteries, and the battery of the mobile terminal is charged through supplied electric energy using a separate charging apparatus. In general, a separate contact terminal is arranged external to the charging apparatus and the battery, and the charging apparatus and the battery are electrically connected to each other through contact between them.

However, since the contact terminal typically outwardly protrudes in such a contact type charging scheme, the contact terminal is easily contaminated by foreign substances and thus the battery charging may not be correctly performed. Further, the battery charging may also not be correctly performed in a case where the contact terminal is exposed to moisture.

Recently, a new wireless charging or a non-contact charging technology has been developed and used for electronic devices in an effort to solve the above-mentioned problem.

Such a wireless charging technology employs wireless power transmission/reception, and corresponds to, for example, a system in which a battery can be automatically charged if the battery is laid on a charging pad, without the need of connecting the mobile phone or battery to a separate charging connector. The wireless charging technology is generally known to be used for wireless electric toothbrushes or wireless electric shavers. Accordingly, a waterproof function can be improved since these electronic products are wirelessly charged through the wireless charging technology, and the portability of the electronic devices can be increased since there is no need to provide a wired charging apparatus. Therefore, technologies related to wireless charging are expected to be significantly developed in coming age of electric cars.

The wireless charging technology typically includes an electromagnetic induction scheme using a coil, a resonance scheme using a resonance, and an RF/microwave radiation scheme converting electrical energy to microwaves and then transmitting the microwaves.

It has been considered up to now that the electromagnetic induction scheme is mainstream, but it is expected that the day will come when all electronic products are charged, anytime and anywhere, without a wire in the near future on the strength of recent successful experiments for wirelessly transmitting power to a destination that can be dozens of meters away through the use of microwaves at home and abroad.

A power transmission method through electromagnetic induction corresponds to a scheme of transmitting power between a first coil and a second coil. When a magnet approaches the coil, an induced current is generated. A transmission side generates a magnetic field using the induced current and a reception side generates energy through an induced current according to changes in the magnetic field. This phenomenon is referred to as magnetic induction, and the power transmission method using magnetic induction has a high energy transmission efficiency.

With respect to the resonance scheme, a system in which electricity is wirelessly transferred using a resonance scheme based on a coupled mode theory has been developed even if a device to be charged is separated from a charging device by several meters. An electromagnetic wave is resonated, containing electrical energy instead of resonating sounds. The resonated electrical energy is directly transferred only when there is a device having a resonance frequency and parts of electrical energy which are not used are reabsorbed into an electromagnetic field instead of being spread in the air, so that it is considered that the electrical energy does not affect surrounding machines or people, unlike other electromagnetic waves.

Meanwhile, a need exists for a standard for a configuration and a procedure in which the wireless power receiver selects the wireless power transmitter to receive wireless power.

The wireless power transmitter and the wireless power receiver may perform communication based on a predetermined scheme, for example, a Zig-Bee scheme or a Bluetooth low energy scheme. By an out-band scheme such as the Zig-Bee scheme or the Bluetooth low energy scheme, an available distance of communication increases. Accordingly, even when the wireless power transmitter and the wireless power receiver are disposed a relatively far distance from each other, the wireless power transmitter and the wireless power receiver may perform the communication. That is, the wireless power transmitter may perform communication with the wireless power receiver even though the wireless power transmitter is located a relatively far distance where wireless power generally cannot be transmitted.

In FIG. 1, a first wireless power transmitter TX1 and a second wireless power transmitter TX2 are disposed. Further, a first wireless power receiver RX1 is disposed on the first wireless power transmitter TX1, and a second wireless power receiver RX2 is disposed on the second wireless power transmitter TX2. Here, the first wireless power transmitter TX1 transmits power to the first wireless power receiver RX1 located near the first wireless power transmitter TX1. In addition, the second wireless power transmitter TX2 transmits power to the second wireless power receiver RX2 located near the second wireless power transmitter TX2. Accordingly, it is preferable that the first wireless power transmitter TX1 performs communication with the first wireless power receiver RX1 and the second wireless power transmitter TX2 performs communication with the second wireless power receiver RX2.

However, according to an increase in a communication distance, the first wireless power receiver RX1 may join a wireless power network controlled by the second wireless power transmitter TX2, and the second wireless power receiver RX2 may join a wireless power network controlled by the first wireless power transmitter TX1. This is called cross-connection. Accordingly, a problem may occur in which the first wireless power transmitter TX1 transmits power requested by the second wireless power receiver RX2, not power requested by the first wireless power receiver RX1. When a capacity of the second wireless power receiver RX2 is larger than that of the first wireless power receiver RX1, over capacity power may be applied to the first wireless power receiver RX1, which causes a problem. Further, when the capacity of the second wireless power receiver RX2 is smaller than that of the first wireless power receiver RX1, a problem occurs in which the first wireless power receiver RX1 receives power less than or equal to its charging capacity.

### SUMMARY OF THE INVENTION

The present invention has been made to solve the above problems and/or disadvantages occurring in the prior art, and to provide the advantages described below. Accordingly, the present invention has been made to address the problem of cross-connection, and provides a wireless power transmitter excluding a wireless power receiver which is crossly connected, and a control method thereof

In accordance with an aspect of the present invention, a control method of a wireless power transmitter for transmitting charging power to a wireless power receiver is provided. The control method includes receiving a communication request signal for transmitting wireless power from the wireless power receiver; determining whether to set a communication with the wireless power receiver based on the received communication request signal; when it is determined to set the communication with the wireless power receiver, transmitting a charge command signal to control an on state of a load switch at a predetermined point in time to the wireless power receiver; applying the charging power; and detecting a load change by the wireless power receiver at the predetermined point in time.

In accordance with another aspect of the present invention, a wireless power transmitter for transmitting charging power to a wireless power receiver is provided. The wireless power transmitter includes a communication unit for receiving a communication request signal for transmitting wireless power from the wireless power receiver; a controller for determining whether to set a communication with the wireless power receiver based on the received communication request signal, and controlling the communication unit to transmit a charge command signal to control an on state of a load switch at a predetermined point in time to the wireless power receiver when it is determined that the wireless power receiver communicates with a wireless power network; and a power transmitter for applying the charging power, wherein the controller detects a load change by the wireless power receiver at the predetermined point in time.

In accordance with yet another aspect of the present invention, a control method of a wireless power receiver for receiving charging power from a wireless power transmitter is provided. The control method includes transmitting a communication request signal for communicating with the wireless power transmitter; receiving a charge command signal to control an on state of a load switch at a predetermined point in time from the wireless power transmitter; and receiving the charging power from the wireless power transmitter by controlling the load switch to be in the on state at the predetermined point in time.

In accordance with still another aspect of the present invention, a wireless power receiver for receiving charging power from a wireless power transmitter is provided. The wireless power receiver includes a communication unit for transmitting a communication request signal for communicating with the wireless power transmitter and receiving a charge command signal to control an on state of a load switch at a predetermined point in time from the wireless power transmitter; a charging unit for receiving the charging power from the wireless power transmitter; the load switch for controlling a state of connection to the charging unit to be an on or off state; and a controller for controlling the load switch to be in the on state at the predetermined point in time.

In accordance with still yet another aspect of the present invention, a control method of a wireless power transmitter for transmitting charging power to a wireless power receiver is provided. The control method includes receiving a wireless power transmitter search signal for searching for the wireless power transmitter from the wireless power receiver; determining whether a load change by the wireless power receiver is detected; and when the load change is detected, letting the wireless receiver join a wireless power network controlled by the wireless power transmitter.

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1 is a diagram for describing the concept of cross-connection;

FIG. 2 is a block diagram for describing a total wireless charging system operation;

FIG. 3A is a block diagram of a wireless power transmitter and a wireless power receiver according to an embodiment of the present invention;

FIG. 3B is a block diagram of a wireless power receiver according to an embodiment of the present invention;

FIG. 4 is a flowchart describing a control method of a wireless power transmitter according to an embodiment of the present invention;

FIG. 5 is a flowchart describing a control method of a wireless power transmitter according to another embodiment of the present invention;

FIG. 6 is a timing diagram describing an operation during a charging process of a wireless power transmitter and a wireless power receiver;

FIG. 7A is a diagram describing another embodiment of the present invention;

FIG. 7B is a timing diagram describing an embodiment of the present invention for solving problems illustrated in FIG. 7A;

FIG. 8A is a diagram describing another embodiment of the present invention; and

FIG. 8B is a timing diagram describing signal transmission/reception between a wireless power transmitter and wireless power receivers of FIG. 8A.

### DETAILED DESCRIPTION OF EMBODIMENTS OF THE PRESENT INVENTION

Hereinafter, various embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention unclear.

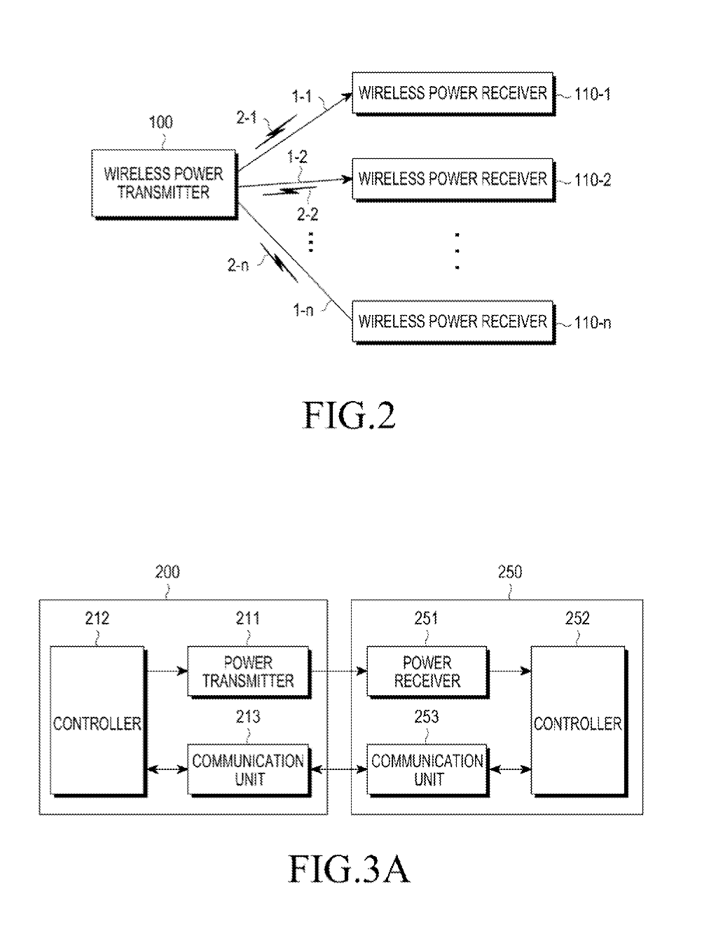

FIG. 2 is a conceptual diagram for describing a total wireless charging system operation. As illustrated in FIG. 2, a wireless charging system includes a wireless power transmitter 100 and one or more wireless power receivers 110-1, 110-2, and 110-3.

The wireless power transmitter 100 may wirelessly transmit power 1-1, 1-2, and 1-n to the one or more wireless power receivers 110-1, 110-2, and 110-3, respectively. More specifically, the wireless power transmitter 100 may wirelessly transmit the power 1-1, 1-2, and 1-n only to an authenticated wireless power receiver having passed through a predetermined authentication procedure.

The wireless power transmitter 100 configures an electrical connection with the wireless power receivers 110-1, 110-2, and 110-n. For example, the wireless power transmitter 100 transmits wireless power in an electromagnetic wave type to the wireless power receivers 110-1, 110-2, and 110-n.

The wireless power transmitter 100 performs bidirectional communication with the wireless power receivers 110-1, 110-2, and 110-n. Here, the wireless power transmitter 100 and the wireless power receivers 110-1, 110-2, and 110-n process or transmit/receive packets 2-1, 2-2, and 2-n consisting of predetermined frames. The frames will be described below in more detail. Particularly, the wireless power receiver may be implemented by a mobile communication terminal, a PDA, a PMP, a smart phone or the like.

The wireless power transmitter 100 wirelessly provides power to a plurality of wireless power receivers 110-1, 110-2, and 110-n. For example, the wireless power transmitter 100 may transmit power to the plurality of wireless power receivers 110-1, 110-2, and 110-n through a resonant scheme. When the wireless power transmitter 100 adopts the resonant scheme, it is preferable that a distance between the wireless power transmitter 100 and the plurality of wireless power receivers 110-1, 110-2, and 110-n is less than or equal to 30 m. Further, when the wireless power transmitter 100 adopts an electromagnetic induction scheme, it is preferable that a distance between the wireless power transmitter 100 and the plurality of wireless power receivers 110-1, 110-2, and 110-n is less than or equal to 10 cm.

The wireless power receivers 110-1, 110-2, and 110-n receive wireless power from the wireless power transmitter 100 to charge batteries therein. Further, the wireless power receivers 110-1, 110-2, and 110-n may transmit a signal for requesting wireless power transmission, information required for wireless power reception, state information of the wireless power receiver, or control information of the wireless power transmitter 100 to the wireless power transmitter 100. Information on a transmission signal will be described below in more detail.

Further, the wireless power receivers 110-1, 110-2, and 110-n transmit a message indicating a charging state of each of the wireless power receivers 110-1, 110-2, and 110-n to the wireless power transmitter 100.

The wireless power transmitter 100 includes a display means such as a display, and displays a state of each of the wireless power receivers 110-1, 110-2, and 110-n based on the message received from each of the wireless power receivers 110-1, 110-2, and 110-n. Further, the wireless power transmitter 100 also displays a charging time until each of the wireless power receivers 110-1, 110-2, and 110-n is completely charged.

The wireless power transmitter 100 transmits a control signal for disabling a wireless charging function to each of the wireless power receivers 110-1, 110-2, and 110-n. The wireless power receivers having received the disable control signal of the wireless charging function from the wireless power transmitter 100 disable the wireless charging function.

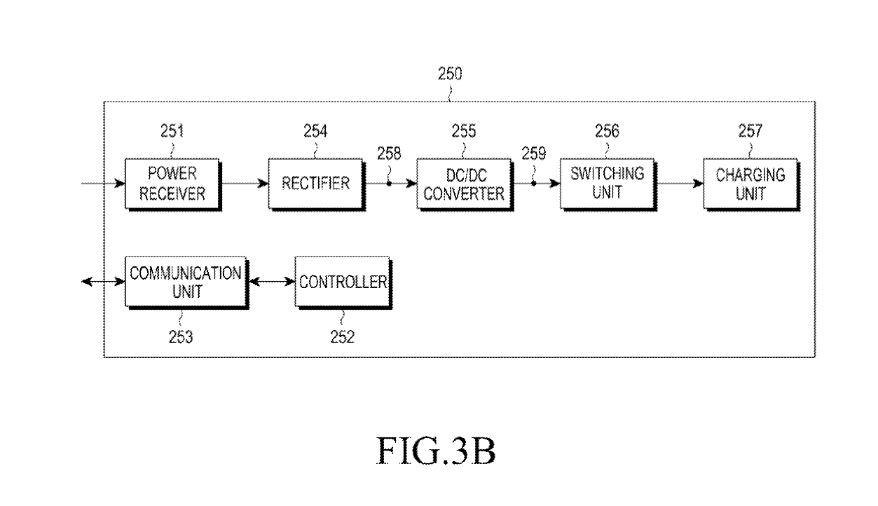

FIG. 3A is a block diagram of the wireless power transmitter and the wireless power receiver according to an embodiment of the present invention.

As illustrated in FIG. 3A, a wireless power transmitter 200 includes a power transmitter 211, a controller 212, and a communication unit 213. Further, a wireless power receiver 250 includes a power receiver 251, a controller 252, and a communication unit 253.

The power transmitter 211 provides power required by the wireless power transmitter 200 and wirelessly provides the power to the wireless power receiver 250. Here, the power transmitter 211 may directly supply power in a AC waveform type, or convert power in a DC waveform type, which is being supplied, to the power in the AC waveform type to finally supply the power in the AC waveform type. The power transmitter 211 may be implemented in a form of the battery therein, or may be implemented in a form of a power reception interface to receive power from the outside and supply the received power to other components. It will be easily understood by those skilled in the art that the power transmitter 211 has no limitation as long as the power transmitter is a means capable of providing constant AC waveform power.

Further, the power transmitter 211 provides the AC waveform in an electromagnetic wave type to the wireless power receiver 250. The power transmitter 211 includes a loop coil, and accordingly, transmits or receives a predetermined electromagnetic wave. When the power transmitter 211 is implemented by the loop coil, inductance L of the loop coil may be changeable. Meanwhile, it will be easily understood by those skilled in the art that the power transmitter 211 has no limitation as long as the power transmitter 211 is a means capable of transmitting/receiving the electromagnetic wave.

The controller 212 controls a total operation of the wireless power transmitter 200. The controller 212 controls the total operation of the wireless power transmitter 200 by using an algorithm, a program, or an application, required for the control, read from a storage unit (not shown). The controller 212 may be implemented in a form of a CPU, a microprocessor, or a mini computer. A detailed operation of the controller 212 will be described below in more detail.

The communication unit 213 performs communication with the wireless power receiver 250 through a predetermined method. The communication unit 213 may perform the communication with the communication unit 253 of the wireless power receiver 250 using Near Field Communication (NFC), ZigBee communication, infrared communication, visible ray communication, or the like. The communication unit 213 according to an embodiment of the present invention performs communication by using ZigBee communication of IEEE802.15.4, and uses a Carrier Sense Multiple Access with Collision Avoidance (CSMA/CA) algorithm. A configuration of selecting a frequency and a channel used by the communication unit 213 will be described below in more detail. Meanwhile, the aforementioned communication method is only an example, but the scope of the present invention is not limited by the particular communication method performed by the communication unit 213.

The communication unit 213 transmits a signal for information on the wireless power transmitter 200. Here, the communication unit 213 may unicast, multicast, or broadcast the signal. Table 1 shows a data structure of a signal transmitted from the wireless power transmitter 200 according to an embodiment of the present invention. The wireless power transmitter 200 transmits a signal having the following frame on every preset period, and the signal is referred to as a notice signal hereinafter.

TABLE 1

| | | | | RX to | | |
|---|---|---|---|---|---|---|
| | | | | Report | | |
| Frame | Protocol | Sequence | Network | (schedule | Re- | Number |
| type | version | number | ID | mask) | served | of Rx |
| Notice | 4 bit | 1 Byte | 1 Byte | 1 Byte | 5 bit | 3 bit |

A frame type in Table 1 corresponds to a field indicating a type of signal, and indicates that a corresponding signal is a notice signal in Table 1. A protocol version field is a field indicating a type of protocol of a communication scheme and may be allocated, for example, 4 bits. A sequence number field is a field indicating a sequential order of the corresponding signal and may be allocated, for example, 1 byte. For example, the sequence number may increase by one for each signal transmission/reception step. A network ID field is a field indicating a network ID of the wireless power transmitter 200 and may be allocated, for example, 1 byte. An Rx to Report (schedule mask) field is a field indicating wireless power receivers for providing a report to the wireless power transmitter 200 and may be allocated, for example, 1 byte. Table 2 shows the Rx to Report (schedule mask) field according to an embodiment of the present invention.

TABLE 2
Rx to Report (schedule mask)

| Rx1 | Rx2 | Rx3 | Rx4 | Rx5 | Rx6 | Rx7 | Rx8 |
|---|---|---|---|---|---|---|---|
| 1 | 0 | 0 | 0 | 0 | 1 | 1 | 1 |

Here, Rx1 to Rx8 correspond to first to eighth wireless power receivers. The Rx to Report (schedule mask) field is implemented such that the wireless power receiver having a schedule mask number of 1 provides a report.

Referring back to table 1, a reserved field is a field reserved for being used in the future and may be allocated, for example, bytes. A number of Rx field is a field indicating the number of wireless power receivers located near the wireless power transmitter 200 and may be allocated, for example, 3 bits.

Meanwhile, the signal having the frame type of Table 1 may be implemented in a form of being allocated to Wireless Power Transmission(WPT) of a data structure in an IEEE802.15.4 form. Table 3 shows a data structure of IEEE802.15.4.

TABLE 3

| | | | | |
|---|---|---|---|---|
| Preamble | SFD | Frame Length | WPT | CRC16 |

As shown in Table 3, the data structure of IEEE802.15.4 includes fields of Preamble, Start Frame Delimiter (SFD), Frame Length, WPT, and Cyclic Redundancy Check(CRC)16, and the data structure shown in Table 1 may be included in the WPT field.

The communication unit 213 receives power information from the wireless power receiver 250. Here, the power information may include at least one of a capacity, a residual quantity of the battery, the number of times of charging, a usage quantity, a battery capacity, and a battery ratio of the wireless power receiver 250. Further, the communication unit 213 transmits a charging function control signal for controlling a charging function of the wireless power receiver 250. The charging function control signal is a control signal for enabling or disabling the charging function by controlling the power receiver 251 of the particular wireless power receiver 250.

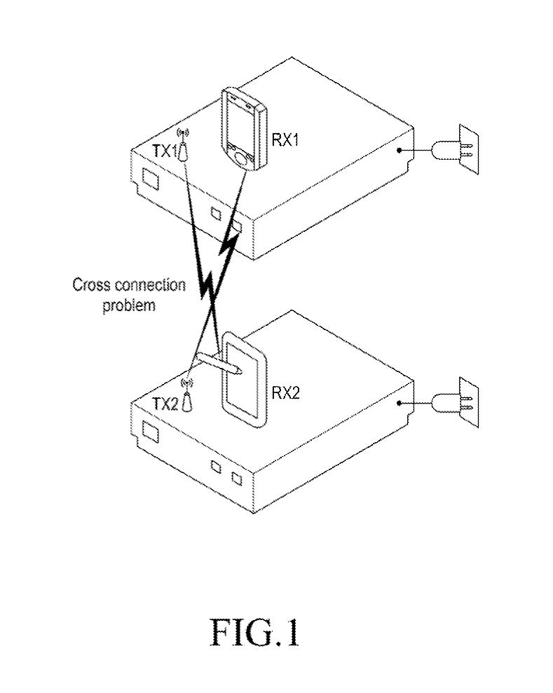

The communication unit 213 may receive signals from another wireless power transmitter (not shown) as well as the wireless power receiver 250. For example, the communication unit 213 may receive the notice signal of the frame of FIG. 1 from another wireless power transmitter.

Meanwhile, although it is illustrated that the power transmitter 211 and the communication unit 213 are configured as different hardware so that the wireless power transmitter 200 communicates in an out-band type in FIG. 3A, this is only an example.

According to the present invention, the power transmitter 211 and the communication unit 213 may be implemented as a single hardware unit so that the wireless power transmitter 200 can communicate in an in-band type.

The wireless power transmitter 200 and the wireless power receiver 250 transmit/receive various types of signals, and accordingly, the wireless power receiver 250 may join the wireless power network controlled by the wireless power transmitter 200 and the charging process through the wireless power transmission/reception may be performed, which will be described below in more detailed.

FIG. 3B is a block diagram of the wireless power receiver according to an embodiment of the present invention.

As illustrated in FIG. 3B, the wireless power receiver 250 includes the power receiver 251, the controller 252, the communication unit 253, a rectifier 254, a DC/DC converter 255, a switching unit 256 and a charging unit 257.

Descriptions of the power receiver 251, the controller 252, and the communication unit 253 will be omitted here. The rectifier 254 rectifies wireless power received from the power receiver 251 to DC power and may be implemented, for example, as a bridge diode type. The DC/DC converter 255 converts the rectified power to a preset gain. For example, the DC/DC converter 255 may convert the rectified power such that a voltage at an output terminal 259 becomes 5 V. Meanwhile, a minimum value and a maximum value of a voltage applied to a front end 258 of the DC/DC converter 255 may be preset, and aforementioned information may be recorded in an input voltage MN field and an input voltage MAX field of a request join signal described below.

Further, a rated voltage applied to the rear end 259 of the DC/DC converter 255 and a rated current flowing to the rear end 259 may be included in a typical output voltage field and a typical output current field of the request join signal.

The switching unit 256 connects the DC/DC converter 255 with the charging unit 257. The switching unit 256 maintains an on/off state according to a control of the controller 252. The charging unit 257 stores the converted power received from the DC/DC converter 255 when the switch unit 256 is in the on state.

According to an embodiment of the present invention, the communication unit 253 receives the command signal for starting charging at a predetermined time. The control unit 252 controls the switch unit 256 to maintain an on state at the predetermined time based on the received command signal.

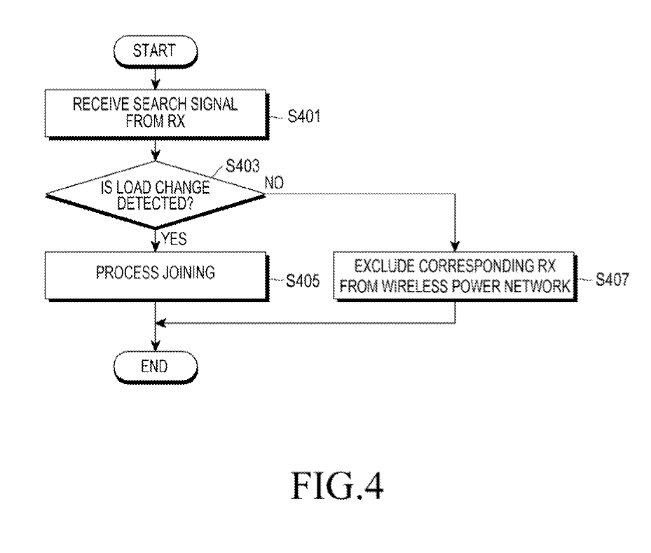

FIG. 4 is a flowchart for describing a control method of the wireless power transmitter according to an embodiment of the present invention.

As illustrated in FIG. 4, the wireless power transmitter receives a wireless power transmitter search signal (hereinafter, referred to as a search signal) from the wireless power receiver in step S401. Here, the search signal has a data structure as shown in Table 4 below.

TABLE 4

| Frame | Protocol | Sequence | Company | Product | | |
|---|---|---|---|---|---|---|
| Type | Version | Number | ID | ID | Impedence | Class |
| Search | 4 bit | 1 Byte | 1 Byte | 4 Byte | 4 bit | 4 bit |

In Table 4, a frame type corresponds to a field indicating a type of signal, and indicates that a corresponding signal is a search signal in Table 4. A protocol version field is a field indicating a type of protocol of a communication scheme and may be allocated, for example, 4 bits. A sequence number field is a field indicating a sequential order of the corresponding signal and may be allocated, for example, 1 byte. For example, the sequence number may increase by one for each signal transmission/reception step.

That is, when the sequence number of the notice signal of Table 1 is 1, the sequence number of the search signal of Table 4 may be 2. A company ID field is a field indicating manufacturer information of the wireless power receiver and may be allocated, for example, 1 byte. A product ID field is a field indicating product information of the wireless power receiver and may include, for example, serial number information on the wireless power receiver. The product ID field may be allocated, for example, 4 bytes. An impedence field is a field indicating impedence information of the wireless power receiver and may be allocated, for example, 4 bits. A class field is a field indicating rated power information of the wireless power receiver and may be allocated, for example, 4 bits.

Meanwhile, when the search signal is received in step S401, the wireless power transmitter detects whether there is a load change. When it is determined that there is the load change in step S405-Y, it is determined that the wireless power receiver having transmitted the search signal is disposed on the wireless power transmitter. The wireless power transmitter then lets the corresponding wireless power receiver join the wireless power network in step S405. Meanwhile, when it is determined that the load change is not detected in step S405-N, it is determined that the wireless power receiver having transmitted the search signal is not disposed on the wireless power transmitter. For example, the wireless power transmitter may determine that the corresponding wireless power receiver is disposed on another wireless power transmitter. The wireless power transmitter excludes the corresponding wireless power receiver from the wireless power network in step S407. When the wireless power receiver is disposed on the wireless power transmitter, a load or impedance at one point of the wireless power transmitter may be changed. However, when the wireless power receiver is disposed on another wireless power transmitter, the load or impedance at the one point of the wireless power transmitter does not change. Accordingly, the wireless power transmitter determines whether the wireless power receiver is disposed on the wireless power transmitter or another wireless power transmitter through the detection of the load change.

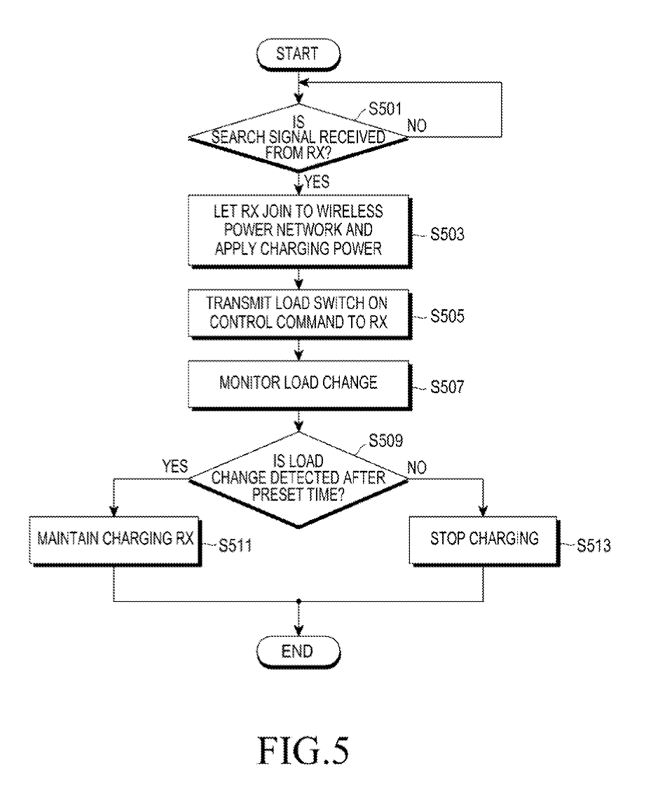

FIG. 5 is a flowchart for describing a control method of the wireless power transmitter according to another embodiment of the present invention.

As illustrated in FIG. 5, the wireless power transmitter receives, for example, a search signal having a data structure as shown in Table 1 from the wireless power receiver in step S501. When the search signal is received in step S501, the wireless power transmitter lets the corresponding wireless power receiver join a wireless power network controlled by the wireless power transmitter and applies charging power to the joined wireless power receiver in step S503.

Meanwhile, the wireless power transmitter transmits a load switch on control command for controlling the wireless power receiver such that the load switch becomes the on state at a particular point in time in step S505. Here, the load switch may be the switch connected to the charging unit. Based on the received load switch on control command, the wireless power receiver may control the load switch to be in the on state. Meanwhile, after transmitting the load switch on control command, the wireless power transmitter monitors whether there is a load change in step S507. When the load switch is controlled to be in the on state, the load is connected to the wireless power receiver, and the load value at one point of the wireless power transmitter may be changed.

When the wireless power receiver controls the load switch to be in the on state at a particular point in time, the wireless power transmitter detects the corresponding load change in step S509-Y. The wireless power transmitter identifies that the wireless power receiver is disposed on the wireless power transmitter, and continues to charge the wireless power receiver in step S511.

Meanwhile, when the wireless power receiver is disposed on a different wireless power transmitter, the wireless power transmitter does not detect the load change due to the control of the on state of the load switch of the wireless power receiver in step S509-N. When the load change is not detected, the wireless power transmitter identifies that the wireless power receiver is disposed on another wireless power transmitter and stops charging the wireless power receiver in step S513.

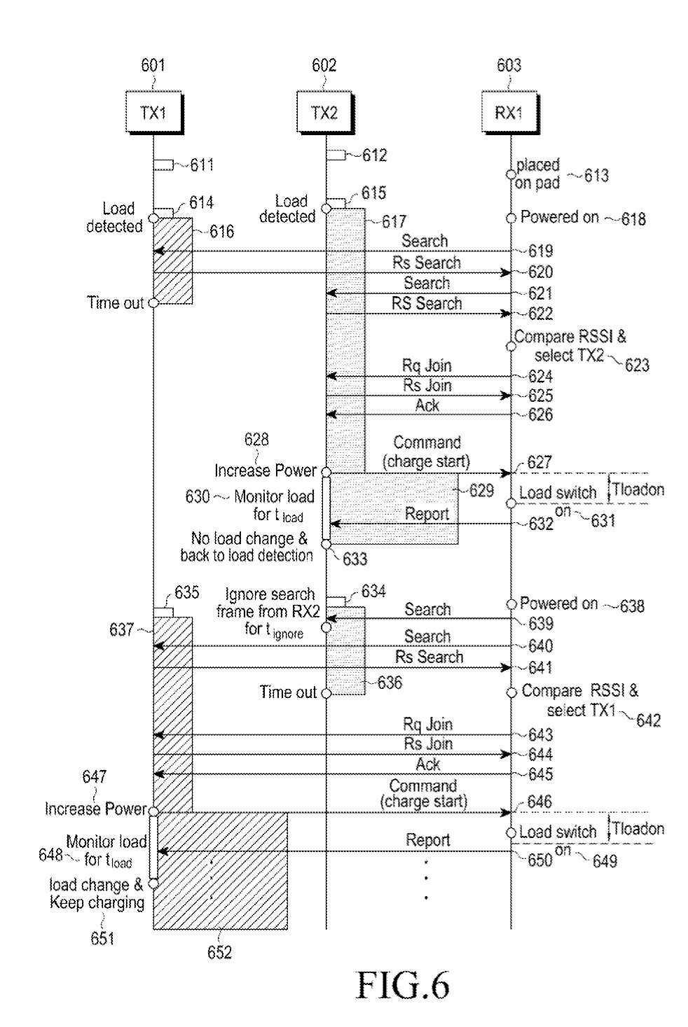

FIG. 6 is a timing diagram for describing an operation during a charging process of the wireless power transmitter and the wireless power receiver. In an embodiment of FIG. 6, it is assumed that there are two wireless power transmitters including a first wireless power transmitter 601 and a second wireless power transmitter 602. Further, it is assumed that one wireless power receiver 603 is disposed on the first wireless power transmitter 601. In addition, it is assumed that the wireless power receiver 603 is disposed at a communicable distance from both the first wireless power transmitter 601 and the second wireless power transmitter 602. Furthermore, it is assumed that both the first wireless power transmitter 601 and the second wireless power transmitter 602 can detect a load change by the disposition of the wireless power receiver 603.

The first wireless power transmitter 601 periodically or aperiodically applies detection power 611 and 614 for detecting the wireless power receiver 603. The second wireless power transmitter 602 periodically or aperiodically applies detection power 612 and 615 for detecting the wireless power receiver 603. Here, the detection power is power applied for detecting the wireless power receiver 603 by the first wireless power transmitter 601 or the second wireless power transmitter 602. As described above, when the wireless power receiver 603 is disposed on one of the wireless power transmitters, a load or impedance at one point of the corresponding wireless power transmitter may be changed. The first wireless power transmitter 601 or the second wireless power transmitter 602 detects the load change at the one point based on detection power while applying the corresponding detection power. The user disposes the first wireless power receiver 603 on the first wireless power transmitter 601 in step 613.

The first wireless power transmitter 601 detects the load change during a process of applying detection power 614. The first wireless power transmitter 601 may stop applying the detection power 614 and apply driving power 616. The second wireless power transmitter 602 detects the load change during a process of applying the detection power 615. The second wireless power transmitter 602 may stop applying the detection power 615 and apply driving power 617. Here, the driving power may have a power quantity for driving a controller or an MCU of the wireless power receiver 603 or a power quantity for driving the controller or the Micro Control Unit(MCU) and operating a communication module.

The wireless power receiver 603 transmits the search signal shown in Table 1 based on the applied driving power 616 or 617 in step 619. For example, the wireless power receiver may transmit the search signal based on a multicast or a broadcast technique. Accordingly, both the first wireless power transmitter 601 and the second wireless power transmitter 602 receive the search signal in steps 619 and 621.

The first wireless power transmitter 601 transmits a wireless power transmitter search response signal to the wireless power receiver 603 based on the received search signal in step 620. The second wireless power transmitter 602 also transmits the wireless power transmitter search response signal to the wireless power receiver 603 based on the received search signal in step 622. Here, the wireless power transmitter search response signal has a data structure as shown in Table 5 below and is referred to as a response search signal hereinafter.

TABLE 5

| Frame Type | Reserved | Sequence Number | Network ID |
|---|---|---|---|
| Response Search | 4 bit | 1 Byte | 1 Byte |

A frame type of Table 5 corresponds to a field indicating a type of signal, and indicates that the corresponding signal is a response search signal in Table 5. A reserved field is a field reserved for being used in the future and may be allocated, for example, 4 bits. A sequence number field is a field indicating a sequential order of the corresponding signal and may be allocated, for example, 1 byte. The sequence number may increase by one for each signal transmission/reception step. A network ID field is a field indicating a network ID of the wireless power transmitter and may be allocated, for example, 1 byte.

The wireless power receiver 603 determines the wireless power transmitter to perform the joining from the first wireless power transmitter 601 and the second wireless power transmitter 602 by comparing RSSIs or energy levels of the received response search signals in step 623. For example, the wireless power receiver 603 may determine the second wireless power transmitter 602 as the wireless power transmitter to perform the joining

The wireless power receiver 603 transmits a join request signal to the second wireless power transmitter 602 in step 624. The join request signal may be referred to as a communication request signal, because the join request signal is the signal for setting a communication between the wireless power receiver 603 and the second wireless power transmitter 602. The join request signal is referred to as a request join signal hereinafter, and has a data structure as shown in Table 6.

TABLE 6

| | | | | | Input | Input | Typical | Typical |
|---|---|---|---|---|---|---|---|---|
| Frame | | Sequence | Network | Product | Voltage | Voltage | Output | Output |
| Type | Reserved | Number | ID | ID | MIN | MAX | Voltage | Current |
| Request | 4 bit | 1 Byte | 1 Byte | 4 Byte | 1 Byte | 1 Byte | 1 Byte | 1 Byte |
| join | | | | | | | | |

A frame type of Table 6 corresponds to a field indicating a type of signal, and indicates that the corresponding signal is a request join signal in Table 6. A reserved field is a field reserved for being used in the future and may be allocated, for example, 4 bits. A sequence number field is a field indicating a sequential order of the corresponding signal and may be allocated, for example, 1 byte. For example, the sequence number may increase by one for each signal transmission/reception step. A network ID field is a field indicating a network ID of the wireless power transmitter and may be allocated, for example, 1 byte. A product ID field is a field indicating product information of the wireless power receiver and may include, for example, serial number information of the wireless power receiver. An input voltage MN field is a field indicating a minimum voltage value applied to a front end of a DC/DC inverter (not shown) of the wireless power receiver and may be allocated, for example, 1 byte. An input voltage MAX field is a field indicating a maximum voltage value applied to the front end of the DC/DC inverter (not shown) of the wireless power receiver and may be allocated, for example, 1 byte. A typical output voltage field is a field indicating a rated voltage value applied to a rear end of the DC/DC inverter (not shown) of the wireless power receiver and may be allocated, for example, 1 byte. A typical output current field is a field indicating a rated current value flowing to the rear end of the DC/DC inverter (not shown) of the wireless power receiver and may be allocated, for example, 1 byte.

The second wireless power transmitter 602 transmits a join response signal (hereinafter, referred to as a response join signal) corresponding to the received request join signal in step 625.

The response join signal has a data structure as shown in Table 7.

TABLE 7

| | | Sequence | Network | | Session |
|---|---|---|---|---|---|
| Frame Type | Reserved | Number | ID | Permission | ID |
| Response | 4 bit | 1 Byte | 1 Byte | 4 bit | 4 bit |
| join | | | | | |

A frame type of Table 7 corresponds to a field indicating a type of signal, and indicates that the corresponding signal is a response join signal in Table 7. A reserved field is a field reserved for being used in the future and may be allocated, for example, 4 bits. A sequence number field is a field indicating a sequential order of the corresponding signal and may be allocated, for example, 1 byte. For example, the sequence number may increase by one for each signal transmission/reception step. A network ID field is a field indicating a network ID of the wireless power transmitter and may be allocated, for example, 1 byte. A permission field is a field indicating whether the wireless power receiver joins a wireless power network and may be allocated, for example, 4 bits. For example, when the permission field indicates 1, it means that the wireless power receiver is allowed to join the wireless power network. When the permission field indicates 0, it means that the wireless power receiver is not allowed to join the wireless power network. A session ID field may be a field indicating a session ID assigned to the wireless power receiver by the wireless power transmitter for controlling the wireless power network. The session ID may be allocated, for example, 4 bits. The second wireless power transmitter 602 determines whether to transmit charging power to the wireless power receiver 603 and transmit a result thereof to the wireless power receiver 603 by using the response join signal. Here, it is assumed that the second wireless power transmitter 602 determines to apply the charging power to the wireless power receiver 603.

The wireless power receiver 603 transmits an Ack signal to the second wireless power transmitter 602 in step 626. The second wireless power transmitter 602 transmits a command signal for instructing a charging initiation to the wireless power receiver 603 in step 627.

The command signal has a data structure as shown in Table 8.

TABLE 8

| | Session | Sequence | Network | Command | |
|---|---|---|---|---|---|
| Frame Type | ID | number | ID | Type | Variable |
| Command | 4 bit | 1 Byte | 1 Byte | 4 bit | 4 bit |

A frame type of Table 8 corresponds to a field indicating a type of signal, and indicates that the corresponding signal is a command signal in Table 8. A session field is a field indicating a session ID assigned to each of the wireless power receivers by the wireless power transmitter for controlling the wireless power network. The session ID field may be allocated, for example, 4 bits. A sequence number field is a field indicating a sequential order of the corresponding signal and may be allocated, for example, 1 byte. For example, the sequence number may increase by one for each a signal transmission/reception step. A network ID field is a field indicating a network ID of the wireless power transmitter and may be allocated, for example, 1 byte. A command type field is a field indicating a type of command and may be allocated, for example, 4 bits. Further, a variable field is a field supplementing the command type field and may be allocated, for example, 4 bits. Meanwhile, the command type field and the variable field may have various embodiments as shown in Table 9.

TABLE 9

| Command Type | Variable |
|---|---|
| Charge start | Reserved |
| Charge finish | Reserved |
| Request Report | CTL level |
| Reset | Reset type |
| Channel Scan | Reserved |
| change channel | Channel |
| load switch on | Reserved |

A charge start is a command for instructing the wireless power receiver to initiate the charging. A charge finish is a command for instructing the wireless power receiver to end the charging. A request report is a command for instructing the wireless power receiver to transmit a report signal. A reset is an initialization command. A channel scan is a command for searching for a channel. A channel change is a command for changing a communication channel. A load switch on is a command for controlling a load switch of the wireless power receiver to be in an on state after a preset time.

Meanwhile, the above-listed various commands may be set independently or simultaneously. For example, the command signal may simultaneously instruct to initiate the charging and instruct to control the load switch to be in the on state.

In step 627, the second wireless power transmitter 602 may initiate the charging of the wireless power receiver 603 by instructing to control the load switch to be in the on state. The second wireless power transmitter 602 increases a power quantity to charging power 629 from the driving power 617 in step 628. Further, the second wireless power transmitter 602 monitors whether there is a load change after a preset time in step 630.

Meanwhile, the wireless power receiver 603 initiates the charging and also controls the load switch to be in the on state after a preset time in step 631. The wireless power receiver 603 transmits a report signal to the second wireless power transmitter 602 in step 632.

For example, the report signal has a data structure as shown in Table 10.

TABLE 10

| Frame | Session | Sequence | Network | Input | Output | Output | |
|---|---|---|---|---|---|---|---|
| Type | ID | number | ID | Voltage | Voltage | Current | Reserved |
| Report | 4 bit | 1 Byte | 1 Byte | 1 Byte | 1 Byte | 1 Byte | 1 Byte |

A frame type of Table 10 corresponds to a field indicating a type of signal, and indicates that the corresponding signal is a report signal in Table 10. A session field is a field indicating a session ID assigned to each of the wireless power receivers by the wireless power transmitter for controlling the wireless power network. The session ID field may be allocated, for example, 4 bits. A sequence number field is a field indicating a sequential order of the corresponding signal and may be allocated, for example, 1 byte. For example, the sequence number may increase by one for each signal transmission/reception step. A network ID field is a field indicating a network ID of the wireless power transmitter and may be allocated, for example, 1 byte. An input voltage field is a field indicating a voltage value applied to a front end of a DC/DC inverter (not shown) of the wireless power receiver and may be allocated, for example, 1 byte. An output voltage field is a field indicating a voltage value applied to a rear end of the DC/DC inverter (not shown) of the wireless power receiver and may be allocated, for example, 1 byte. An output current field is a field indicating a rated current value flowing to the rear end of the DC/DC inverter (not shown) of the wireless power receiver and may be allocated, for example, 1 byte.

Meanwhile, as described above, the wireless power receiver 603 may not be disposed on the second wireless power transmitter 602, and accordingly, the second wireless power transmitter 602 may not detect the load change after a preset time (Tloadon) in step 633. Accordingly, the second wireless power transmitter 602 excludes the wireless power receiver 603 from the wireless power network controlled by the second wireless power transmitter 602. In other words, the wireless power transmitter 602 may decide not to form a communication with the wireless power receiver 603. Further, the second wireless power transmitter 602 returns to a load change detection state.

However, when another wireless power receiver instead of the wireless power receiver 603 joins the wireless power network controlled by the second wireless power transmitter 602, the second wireless power transmitter 602 may stop only applying the charging power to the wireless power receiver 603 and continue to charge another wireless power receiver, without returning to the load change detection state. In an embodiment of FIG. 6, it is assumed that the second wireless power transmitter 602 returns to the load change detection state.

Accordingly, the first wireless power transmitter 601 and the second wireless power transmitter 602 apply detection power 634 and 635, respectively. Meanwhile, the wireless power receiver 603 is continuously disposed on the first wireless power transmitter 601. Accordingly, the first wireless power transmitter 601 and the second wireless power transmitter 602 apply driving power 636 and 637, respectively. The wireless power receiver 603 is driven based on the driving power 636 and 637 in step 638. The wireless power receiver 603 transmits a search signal to the first wireless power transmitter 601 and the second wireless power transmitter 602 in steps 639 and 640, respectively. The first wireless power transmitter 601 transmits a response search signal to the wireless power receiver 603 in response to the search signal in step 641. Meanwhile, since the second wireless power transmitter 602 excludes the wireless power receiver 603 from the wireless power network controlled by the second wireless power transmitter 602, the search signal from the wireless power receiver 603 may be ignored for a preset period (tignore). For instance, the second wireless power transmitter 602 may exclude the wireless power receiver 603 from the wireless power network by storing an ID or a serial number of the wireless power receiver 603 and ignoring the search signal transmitted from the corresponding wireless power receiver 603. The wireless power receiver 603 forms a communication with the first wireless power transmitter 601 according to the received response search signal in step 642.

Meanwhile, the wireless power receiver 603 transmits a request join signal to the first wireless power transmitter 601 in step 643. Further, the first wireless power transmitter 601 transmits a response join signal to the wireless power receiver 603 in step 644. The wireless power receiver 603 transmits an Ack signal to the first wireless power transmitter 601 in step 645.

The first wireless power transmitter 601 initiates the charging and control the on state of the load switch at a particular point in time by using a command signal in step 646. Further, the first wireless power transmitter 601 increases applied power to charging power 652 from driving power 637 in step 647. The first wireless power transmitter 601 monitors a load change in step 648. Meanwhile, both the first wireless power transmitter 601 and the wireless power receiver 603 may use a command signal or an Ack signal as a synchronization signal for calculating the predetermined time Tloadon.

Meanwhile, the wireless power receiver 603 initiates the charging and also controls the load switch to be in the on state after a preset time (Tloadon) in step 649.

Further, the wireless power receiver 603 transmits the report signal to the first wireless power transmitter 601 in step 650.

The first wireless power transmitter 601 detects a load change due to an on state control of the load switch after a preset time (Tloadon) in step 651. Accordingly, the first wireless power transmitter 601 determines that the wireless power receiver 603 is disposed on the first wireless power transmitter 601 and continues to charge. The first wireless power transmitter 601 may set up a tolerance for the predetermined time Tloadon. The first power transmitter 601 may continue to charge even though the first power transmitter 601 detects a load change earlier than the predetermined time Tloadon or later than the predetermined time Tloadon.

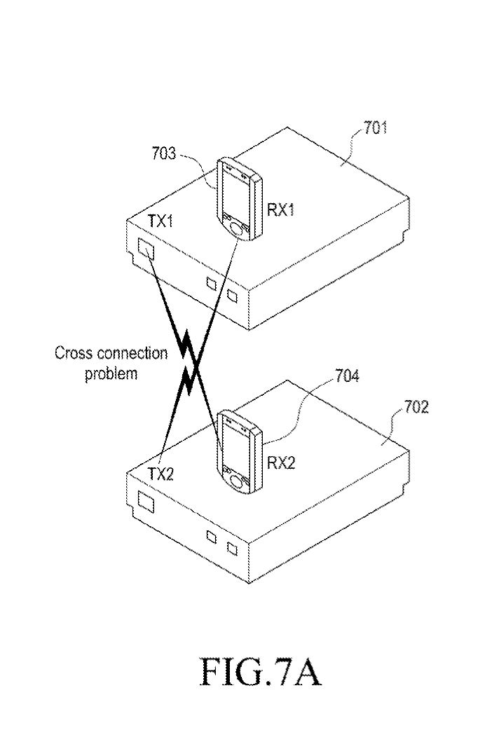

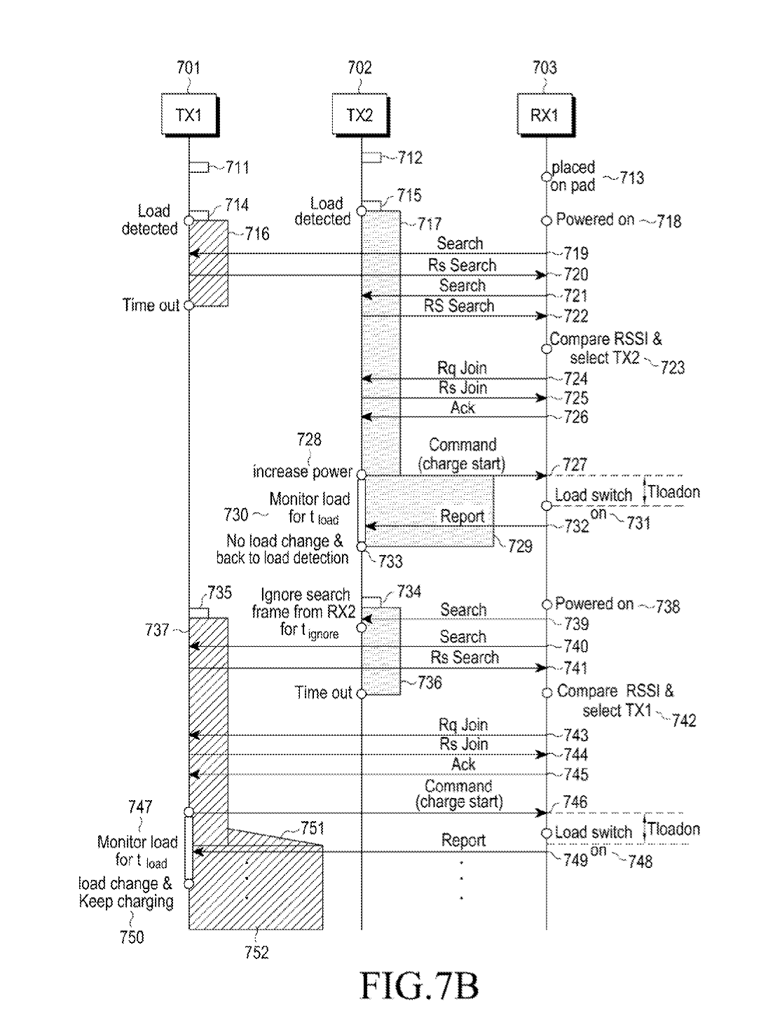

FIG. 7A is a conceptual diagram for describing another embodiment of the present invention. As illustrated in FIG. 7A, a first wireless power transmitter 701 and a second wireless power transmitter 702 are shown. Further, a first wireless power receiver 703 is disposed on the first wireless power transmitter 701, and a second wireless power receiver 704 is disposed on the second wireless power transmitter 702. However, the first wireless power transmitter 701 may communicate with the second wireless power receiver 704, and the second wireless power transmitter 702 may communicate with the first wireless power receiver 703.

FIG. 7B is a flowchart for describing an embodiment of the present invention to solve the problems of FIG. 7A. It is noted that steps 711 to 745 of FIG. 7B are the same as steps 611 to 645 of FIG. 6, and thus descriptions thereof will be omitted.

The first wireless power transmitter 701 instructs the wireless power receiver 703 to initiate charging and controls an on state of the load switch at a particular time point by using a command signal in step 746. The first wireless power transmitter 701 monitors whether there is a load change after a preset time (tloadon) in step 747. The wireless power receiver 703 controls the load switch to be in the on state after the preset time (tloadon) in step 748. The wireless power receiver 703 transmits a report signal to the first wireless power transmitter 701 in step 749. Meanwhile, the first wireless power transmitter 701 maintains applying charging power 752 in step 750 by gradually increasing charging power instead of temporarily increasing the charging power in step 751.

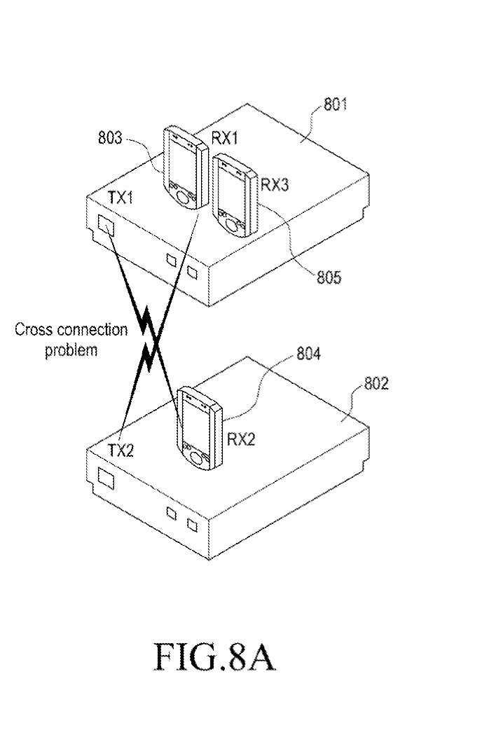

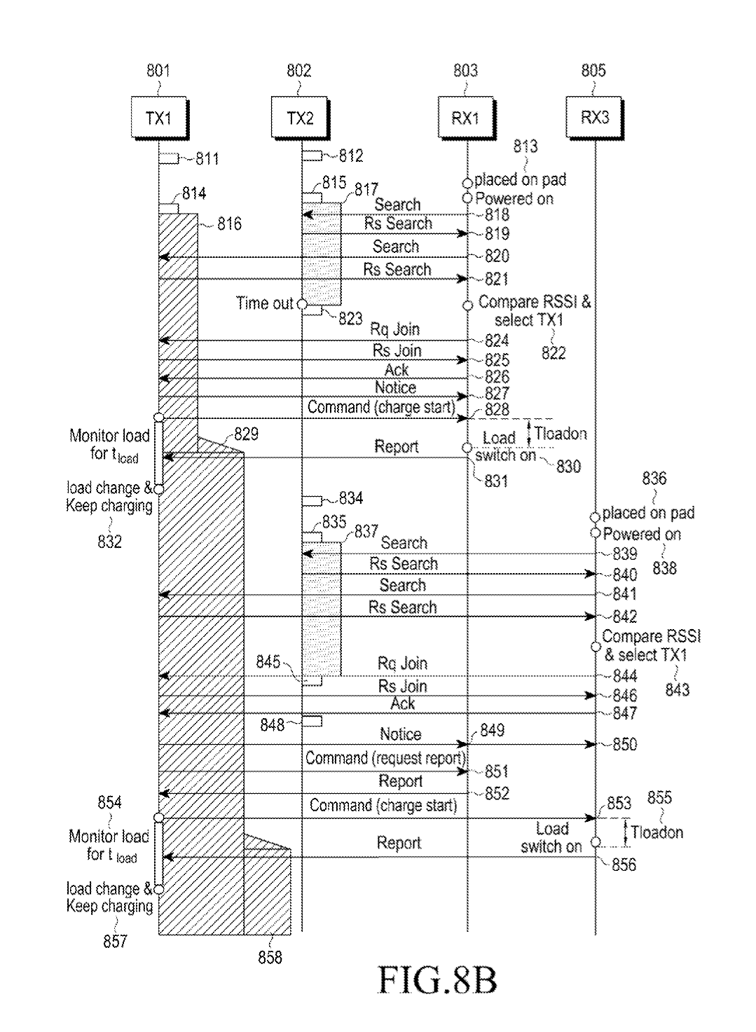

FIG. 8A is a conceptual diagram for describing another embodiment of the present invention. As illustrated in FIG. 8A, a first wireless power transmitter 801 and a second wireless power transmitter 802 are shown. Further, a first wireless power receiver 803 and a third wireless power receiver 805 are disposed on the first wireless power transmitter 801, and a second wireless power receiver 804 is disposed on the second wireless power transmitter 802. However, the first wireless power transmitter 801 may communicate with the second wireless power receiver 804, and the second wireless power transmitter 802 may communicate with the first wireless power receiver 803 and the third wireless power receiver 805. The third wireless power receiver 805 may be disposed after the first wireless power receiver 803.

FIG. 8B is a timing diagram for describing signal transmission/reception between the wireless power transmitter and the wireless power receivers of FIG. 8A.

The first wireless power transmitter 801 periodically or aperiodically applies detection power 811 and 814 for detecting the first wireless power receiver 803. The second wireless power transmitter 802 periodically or aperiodically applies detection power 812 and 815 for detecting the first wireless power receiver 803. Here, the detection power is power applied for detecting the first wireless power receiver 803 by the first wireless power transmitter 801 or the second wireless power transmitter 802. As described above, when the first wireless power receiver 803 is disposed on one of the wireless power transmitters, a load or impedance at one point of the first wireless power transmitter and the second wireless power transmitter may be changed. The first wireless power transmitter 801 or the second wireless power transmitter 802 detects a load change at one point based on detection power while applying the corresponding detection power. The user disposes the first wireless power receiver 803 on the first wireless power transmitter 801 in step 813.

The first wireless power transmitter 801 detects the load change during a process of applying the detection power 814. The first wireless power transmitter 801 stops applying the detection power 814 and applies driving power 816. The second wireless power transmitter 802 detects the load change during a process of applying the detection power 815. The second wireless power transmitter 802 stops applying the detection power 815 and applies driving power 817.

The first wireless power receiver 803 transmits the search signal shown in Table 1 based on the applied driving power 816 or 817 in step 818. For example, the first wireless power receiver 803 may transmit the search signal based on a multicast or a broadcast technique. Accordingly, both the first wireless power transmitter 801 and the second wireless power transmitter 802 receive the search signal in steps 818 and 820.

The first wireless power transmitter 801 transmits a wireless power transmitter search response signal to the first wireless power receiver 803 based on the received search signal in step 821. The second wireless power transmitter 802 also transmits the wireless power transmitter search response signal to the first wireless power receiver 803 based on the received search signal in step 819.

Meanwhile, the first wireless power receiver 803 determines the first wireless power transmitter 801 as a wireless power transmitter to perform joining, based on an RSSI or an energy level of the received response search signal in step 822. The second wireless power transmitter transmits detecting power 823.

The first wireless power receiver 803 transmits a request join signal to the first wireless power transmitter 801 in step 824. The first wireless power transmitter 801 transmits a response join signal to the first wireless power receiver 803 in step 825, and the first wireless power receiver 803 transmits an Ack signal to the first wireless power transmitter 801 in step 826. Meanwhile, the first wireless power transmitter 801 transmits a notice signal to the first wireless power receiver 801 in step 827, and initiates the charging and controls an on state of the load switch at a particular point in time by using a command signal in step 828.

The first wireless power transmitter 801 monitors whether there is a load change after a preset time (tloadon), and increases a power quantity applied to charging power in step 829 when the load change due to an on state 830 of the load switch of the first wireless power receiver 803 is detected.

The wireless power receiver 803 transmits a report signal to the first wireless power transmitter 801 in step 831. Meanwhile, the first wireless power transmitter 801 maintains applying charging power 832 by gradually increasing the charging power 829 instead of temporarily increasing the charging power. Meanwhile, the second wireless power transmitter 802 may periodically apply detection power 834 and 835.

Meanwhile, the third wireless power receiver 805 is disposed on the first wireless power transmitter 801 between applying of the detection power 834 and applying of the detection power 835 in step 836. The second wireless power transmitter 802 applies driving power 837 and the third wireless power receiver 805 turns on in step 838. The third wireless power receiver 805 transmits a search signal to the second wireless power transmitter 802 in step 839, and the second wireless power transmitter 802 transmits a response search signal to the third wireless power receiver 805 in step 840. Further, the third wireless power receiver 805 transmits the search signal to the first wireless power transmitter 801 in step 841, and the first wireless power transmitter 801 transmits the response search signal to the third wireless power receiver 805 in step 842. The third wireless power receiver 805 determines the first wireless power transmitter 801 as a wireless power transmitter to perform joining by comparing RSSIs or energy levels of the response search signals received from the first wireless power transmitter 801 and the second wireless power transmitter 802 in step 843.

The third wireless power receiver 805 transmits a request join signal to the first wireless power transmitter 801 in step 844, and the first wireless power transmitter 801 transmits a response join signal to the third wireless power receiver 805 in step 846. The third wireless power receiver 805 transmits an Ack signal to the first wireless power transmitter 801 in step 847. Meanwhile, during such a process, the second wireless power transmitter 802 periodically applies detection power 845 and 848.

The first wireless power transmitter 801 defines a new period by transmitting a notice signal in step 849 to the first wireless power transmitter 803. The notice signal transmitted from the first wireless power transmitter 801 is also received by the third wireless power receiver 805 in step 850. Meanwhile, the first wireless power transmitter 801 transmits a report signal instructing the first wireless power receiver 803 to report a charging state in step 851. In response to the report signal, the first wireless power receiver 803 transmits a report signal including information such as a charging state, impedance information, remaining charging amount and the like in step 852. Further, the first wireless power transmitter 801 initiates the charging and controls an on state of the load switch at a particular point in time by using a command signal in step 853. Thereafter, the first wireless power transmitter 801 monitors a load change in step 854, and detects the load change by a load switch on after a preset time 855. Meanwhile, the third wireless power receiver 803 transmits the report signal in step 856. The first wireless power transmitter 801 having detected the load change maintains charging power at step 857 which has been gradually increased at 858. According to the above description, when two or more wireless power receivers are disposed, an effect of easily preventing cross-connection may be created.

According to various embodiments of the present invention, it is possible to solve the problem in which a wireless power receiver located on a wireless power transmitter is connected to another wireless power transmitter and receives charging power.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A control method of a wireless power transmitter for transmitting charging power to a wireless power receiver, the control method comprising:
receiving a communication request signal for transmitting wireless power from the wireless power receiver;
determining whether to set a communication with the wireless power receiver based on the received communication request signal;
when it is determined to set the communication with the wireless power receiver, transmitting a charge command signal to control an on state of a load switch at a predetermined point in time to the wireless power receiver;
applying the charging power; and
detecting a load change by the wireless power receiver at the predetermined point in time.

2. The control method of claim 1, further comprising:
comparing the predetermined point in time with a load change detected point in time.

3. The control method of claim 2, further comprising:
maintaining applying the charging power if the predetermined point in time is associated with the load change detected point in time, and stopping applying the charging power if the predetermined point in time is not associated with the load change detected point in time.

4. The control method of claim 1, further comprising:
before receiving the communication request signal for transmitting the wireless power from the wireless power receiver,
applying detection power for detecting the load change;
detecting the load change due to the applied detection power; and
when the load change is detected, applying driving power for driving the wireless power receiver.

5. The control method of claim 4, further comprising, before applying the detection power for detecting the load change, transmitting a notice signal for defining a period of a wireless power network.

6. The control method of claim 1, wherein detecting the load change at the predetermined point in time comprises:
monitoring the load change at one point of the wireless power transmitter; and
detecting the load change due to switching to the on state of the load switch of the wireless power receiver.

7. The control method of claim 1, wherein applying the charging power comprises temporarily increasing a power quantity of the charging power from driving power.

8. The control method of claim 1, wherein applying the charging power comprises gradually increasing a power quantity of the charging power from driving power.

9. The control method of claim 1, further comprising, after determining whether to set the communication with the wireless power receiver, transmitting a response signal indicating whether to set the communication with the wireless power receiver.

10. The control method of claim 9, further comprising, after transmitting the response signal, receiving an Ack signal corresponding to the response signal from the wireless power receiver.

11. A wireless power transmitter for transmitting charging power to a wireless power receiver, the wireless power transmitter comprising:
a communication unit for receiving a communication request signal for transmitting wireless power from the wireless power receiver;
a controller for determining whether to set a communication with the wireless power receiver based on the received communication request signal, and controlling the communication unit to transmit a charge command signal to control an on state of a load switch at a predetermined point in time to the wireless power receiver when it is determined that the wireless power receiver communicates with a wireless power network; and
a power transmitter for applying the charging power,
wherein the controller detects a load change by the wireless power receiver at the predetermined point in time.

12. The wireless power transmitter of claim 11,
wherein the controller compares the predetermined point in time with a load change detected point in time.

13. The wireless power transmitter of claim 12,
wherein the power transmitter maintains applying the charging power if the predetermined point in time is associated with the load change detected point in time, and stops applying the charging power if the predetermined point in time is not associated with the load change detected point in time.

14. The wireless power transmitter of claim 11, wherein, before receiving the communication request signal, the controller controls the power transmitter to apply detection power for detecting the load change, and controls such that driving power for driving the wireless power receiver is applied when the load change due to the applied detection power is detected.

15. The wireless power transmitter of claim 14, wherein, before the detection power for detecting the load change is applied to the power transmitter, the communication unit transmits a notice signal for defining a period of the wireless power network.

16. The wireless power transmitter of claim 11, wherein the controller monitors the load change at one point of the wireless power transmitter and detects the load change due to switching to the on state of the load switch of the wireless power receiver at the predetermined point in time.

17. The wireless power transmitter of claim 11, wherein the controller temporarily increases a power quantity applied to the power transmitter of the charging power from driving power.

18. The wireless power transmitter of claim 11, wherein the controller gradually increases a power quantity applied to the power transmitter of the charging power from driving power.

19. The wireless power transmitter of claim 11, wherein, after determining whether to set the communication with the wireless power receiver, the controller transmits a response signal indicating whether to set the communication with the wireless power receiver.

20. The wireless power transmitter of claim 19, wherein the communication unit receives an Ack signal corresponding to the response signal from the wireless power receiver.

21. A control method of a wireless power receiver for receiving charging power from a wireless power transmitter, the control method comprising:
transmitting a communication request signal for communicating with the wireless power transmitter;
receiving a charge command signal to control an on state of a load switch at a predetermined point in time from the wireless power transmitter;
receiving the charging power from the wireless power transmitter by controlling the load switch to be in the on state at the predetermined point in time.

22. A wireless power receiver for receiving charging power from a wireless power transmitter, the wireless power receiver comprising:
a communication unit for transmitting a communication request signal for communicating with the wireless power transmitter and receiving a charge command signal to control an on state of a load switch at a predetermined point in time from the wireless power transmitter;
a charging unit for receiving the charging power from the wireless power transmitter; the load switch for controlling a state of connection to the charging unit to be an on or off state; and
a controller for controlling the load switch to be in the on state at the predetermined point in time.

23. A control method of a wireless power transmitter for transmitting charging power to a wireless power receiver, the control method comprising:
receiving a wireless power transmitter search signal for searching for the wireless power transmitter from the wireless power receiver;
determining whether a load change by the wireless power receiver is detected; and
when the load change is detected, letting the wireless receiver join a wireless power network controlled by the wireless power transmitter.
